(19) United States
(12) Patent Application Publication
(10) Pub. No.: US 2024/0144197 A1
(43) Pub. Date: May 2, 2024

(54) Task-Based Virtual Calendar Scheduling Assertion

(71) Applicant: Zoom Video Communications, Inc., San Jose, CA (US)

(72) Inventor: Shane Paul Springer, Oregon City, OR (US)

(21) Appl. No.: 17/977,499

(22) Filed: Oct. 31, 2022

(51) Int. Cl. G06Q 10/10; G06Q 10/06

(52) U.S. Cl. CPC G06Q 10/1097; G06Q 10/063116

(57) ABSTRACT

Task-based user schedule changes are asserted within a virtual calendar of a software user. User-specific calendar rules for automated assertion against the virtual calendar of the software user are generated by modeling trend and priority data for meetings and tasks associated with the software user. A set of pending tasks of the software user are obtained. A determination is then made, by asserting the user-specific calendar rules against the virtual calendar, that a priority level of a current task of the set of pending tasks is higher than a priority level of a current meeting scheduled on the virtual calendar. Based on such determination, an adjustment is caused to the virtual calendar to remove the current meeting and add a new event corresponding to the current task. The virtual calendar may in some cases be facilitated by an email client.

### FIELD

This disclosure generally relates to virtual calendars, and, more specifically, to the assertion of task-based user schedule changes within a virtual calendar.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for task-based virtual calendar scheduling assertion.

FIG. 5 is a block diagram of example functionality of task-based virtual calendar scheduling assertion software.

FIGS. 6A-B are illustrations of example graphical user interfaces (GUI) of an email client that facilitates a virtual calendar of a software user.

FIG. 7 is a flowchart of an example of a technique for task-based virtual calendar scheduling assertion.

### DETAILED DESCRIPTION

In today's connected world, many workers are frequently inundated with round-the-clock meetings that tie up valuable work time from their schedules. These workers may have large and growing task lists to action through, but struggle to action many of the items thereon given their busy calendars, which are often filled with meetings. When a worker is not in an active meeting, they may in some cases be faced with the challenge of deciding which task to action at a given time. One approach to resolving this may be to implement a set of rules for helping workers to focus on their tasks, such as by scheduling dedicated focus periods within their calendars; however, every worker has different assignments, schedules, teams, and the like, and their day-to-day operations may fluctuate. As such, there is no one-size-fits-all approach to scheduling dedicated focus periods that equitably accommodates all workers.

Furthermore, given the variance in the tasks themselves, such rigid focus period scheduling approaches, to the extent they even contemplate tasks, may fail to recognize that different tasks have different priority levels. As used herein, a priority level may refer to a measure of importance for attending to a task. For example, a conventional scheduling system that attempts to fill an empty time block within a worker's calendar according to an oldest task on the worker's task list may fail to recognize that another task on the task list has a higher priority, such as due to a more immediate deadline, a deliverable being due to an executive-level team member, or another team depending upon the worker's output to progress in a large project. In another example, such a conventional scheduling system may fail to recognize priorities based on attributes related to the worker's work day, such as where they will be present in a company office for the day and require use of equipment only available at the office to perform one of the many tasks on their task list.

Implementations of this disclosure address problems such as these using task-based virtual calendar scheduling assertion, in which task-based user schedule changes are asserted within a virtual calendar of a software user. User-specific calendar rules for automated assertion against the virtual calendar of the software user are generated by modeling trend and priority data for meetings and tasks associated with the software user. At some point after the user-specific calendar rules are generated, or contemporaneous therewith, a set of pending tasks of the software user are obtained from one or more sources. Priority levels of the tasks of the set of pending tasks are determined. Thereafter, by asserting the user-specific calendar rules against the virtual calendar, a determination is made that a priority level of a current task of the set of pending tasks is higher than a priority level of a current meeting scheduled on the virtual calendar. Based on such determination, an adjustment is caused to the virtual calendar to remove the current meeting and add a new event corresponding to the current task. For example, the adjustment may be caused by an automated update to the virtual calendar using software that facilitates the virtual calendar, such as an email client. The virtual calendar may, for example, be implemented using software services of a software platform (e.g., a unified communications as a service (UCaaS) platform), in which at least some tasks of the set of pending tasks may be derived based on records associated with one or more software services of the software platform.

According to the implementations of this disclosure, a software user, such as a user of a UCaaS or other software platform, can receive recommendations for adjusting their virtual calendar, or simply have their virtual calendar automatically adjusted, to ensure that their time is being efficiently utilized between scheduled meetings that are actually important to the user and tasks that the user must action. To produce such recommendations, meeting and task priorities are modeled by evaluating scheduling trends (e.g., which meetings are actually accepted by the user and placed on their schedule), event trends (e.g., which meetings are actually attended and/or participated in by the user, or which tasks or categories of tasks are most frequently performed by the user), work trends (e.g., which days the user tends to have most of their meetings on, or which days the user arrives late to work on), and the like. When a high priority task is awaiting actioning by the software user or when the user is in need of a focus period, the virtual calendar of the software user can be evaluated to determine a block of time to clear for the software user to action the task (e.g., based on an expected amount of time required to action the task) or to schedule the focus period.

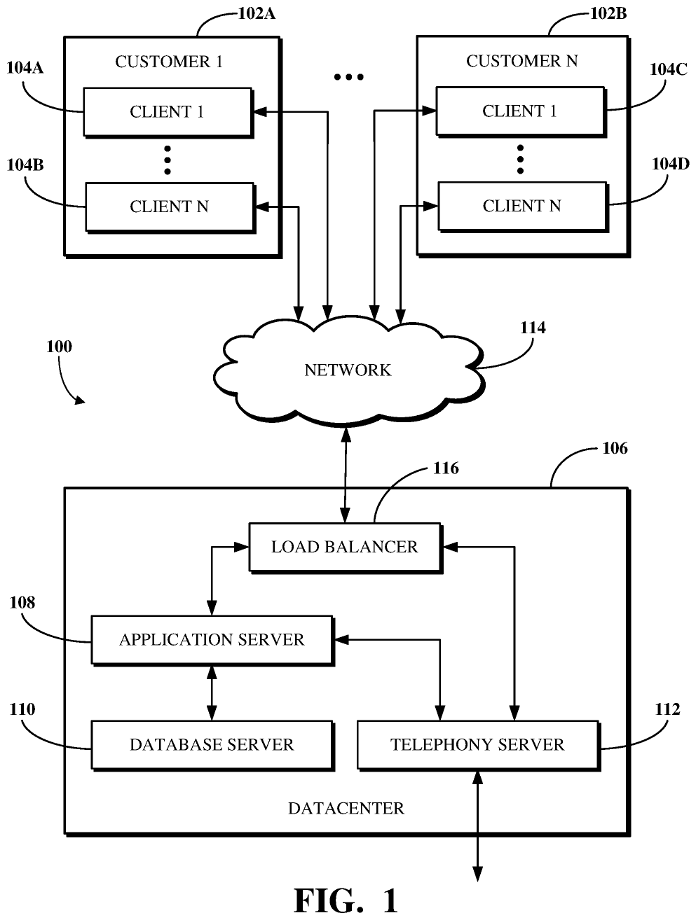

To describe some implementations in greater detail, reference is first made to examples of hardware and software structures used to implement a system for task-based virtual calendar scheduling assertion. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

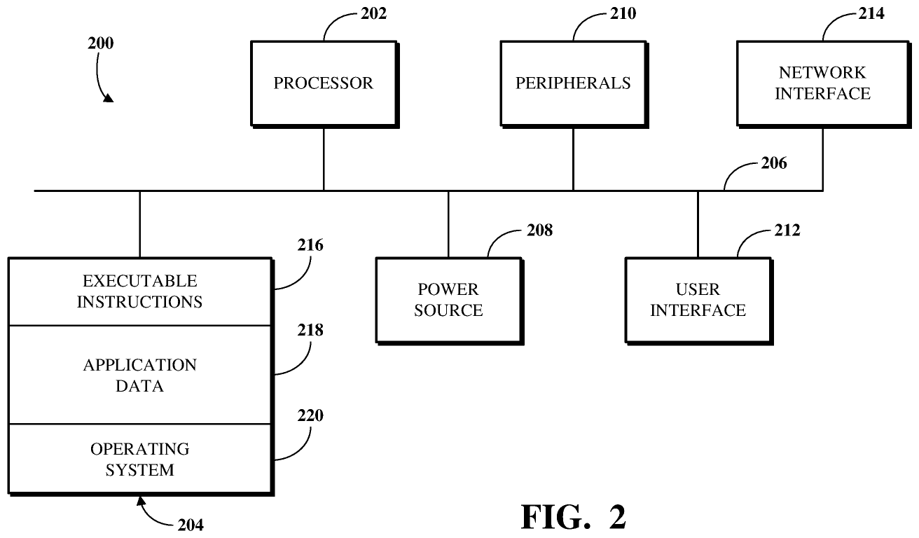

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

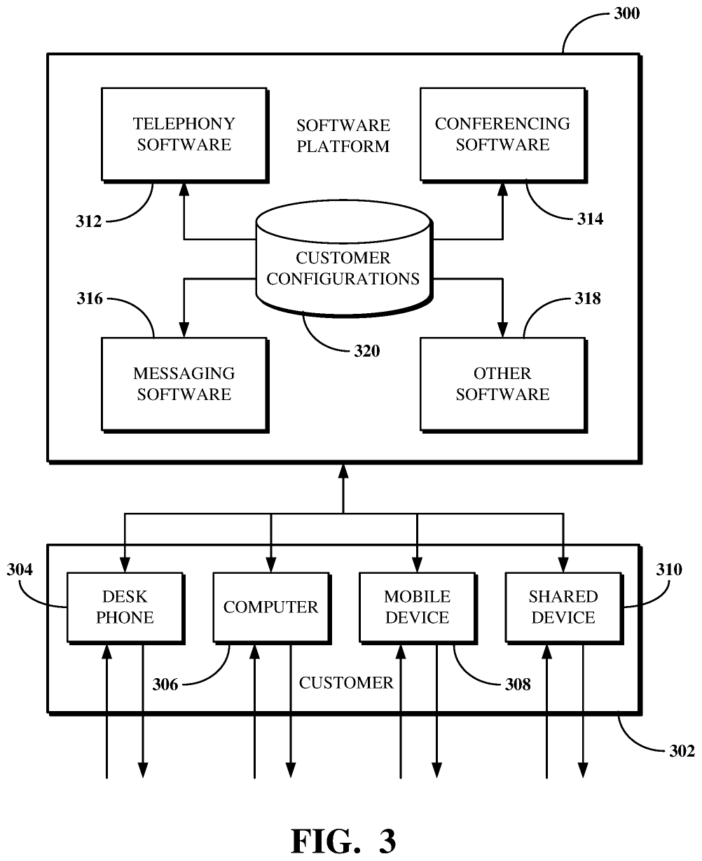

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for task-based virtual calendar scheduling assertion.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

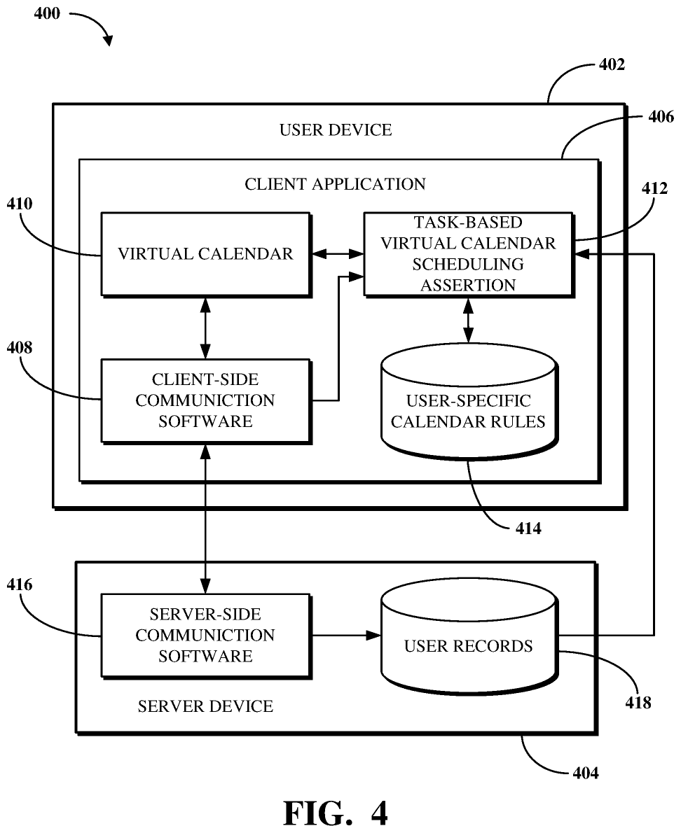

FIG. 4 is a block diagram of an example of a system 400 for task-based virtual calendar scheduling assertion. The system 400 includes a user device 402 used by a software user of a software platform, for example, the software platform 300 shown in FIG. 3, and a server device 404 used to implement one or more software services of that software platform. The user device 402 may referred to as a client device, and may accordingly be, for example, one of the clients 304 through 310 shown in FIG. 3. The server device 404 may, for example, be a server at a datacenter, such as the application server 108 shown in FIG. 1.

The user device 402 runs a client application 406, which is a desktop, mobile, or web-based application for enabling the user device 402 to access and use functionality (e.g., software services and related data) of the software platform. In particular, the client application 406 includes client-side communication software 408, which may correspond to one or more of one or more of an email service, chat service, conferencing (e.g., audio and/or video conferencing) service, and/or telephony service of the software platform. The client application 406, via the client-side communication software 410, accesses and thus enables the software user to use server-side communication software 416 implemented at the server device 404. The server-side communication software 416 implements communications over one or more modalities between the software user and other users of the software platform. The server-side communication software 416 may, for example, be one or more of the software 312 through 318 shown in FIG. 3. For example, the server-side communication software 416 may correspond to one or more of one or more of an email service, chat service, conferencing (e.g., audio and/or video conferencing) service, and/or telephony service of the software platform. The client application 406 further includes a virtual calendar 410, task-based virtual calendar scheduling assertion software 412, and user-specific calendar rules data 414.

The virtual calendar 410 is a digital representation of a calendar for the software user. The virtual calendar 410 depicts meetings and other appointments (e.g., periods set for actioning one or more tasks) for which the software user is scheduled to attend and to which the software user has been invited to attend, as well as times during which the software user is available for other things (e.g., actioning tasks from their task list). For example, events and appointments may be depicted using visual objects (e.g., blocks) placed on the virtual calendar 410 at dates and times corresponding to those events and appointments, whereas available times (i.e., times during which there are no events or appointments for the software user) may be depicted by the omission of such visual objects. In some cases, the virtual calendar 410 may present a limited number of days and/or times for viewing by the software user (e.g., only business hours and/or only the business days of the current week). In other cases, the days and/or times for viewing by the software user within the virtual calendar 410 may be unlimited or practically unlimited (e.g., ranging for more than a year from a current day). Events and appointments within the virtual calendar 410 may include meeting-related information, such as physical and/or virtual locations at which subject meetings will be held. For example, a virtual location may be represented using a hyperlink (e.g., to a conference instance facilitated using software of the software platform, such as the conferencing software 314 shown in FIG. 3). The client application 406 may implement the virtual calendar 410. Alternatively, the client application 406 may access the virtual calendar 410 from an external source, such as software external to the software platform.

The task-based virtual calendar scheduling assertion software 412 generates user-specific calendar rules associated with the software user and asserts same against the virtual calendar 410. A user-specific calendar rule is a rule specific to the software user for adjusting, setting, or otherwise using a virtual calendar of the software user based on meetings and/or tasks of the software user. In particular, a user-specific calendar rule indicates a determined importance of certain meetings or tasks or of certain types of meetings or tasks to the software user. In some cases, a user-specific calendar rule may also or instead indicate a scheduling preference, such as a preference to or not to schedule a meeting or other appointment at one or more certain times independent of or related to one or more existing meetings or other appointments.

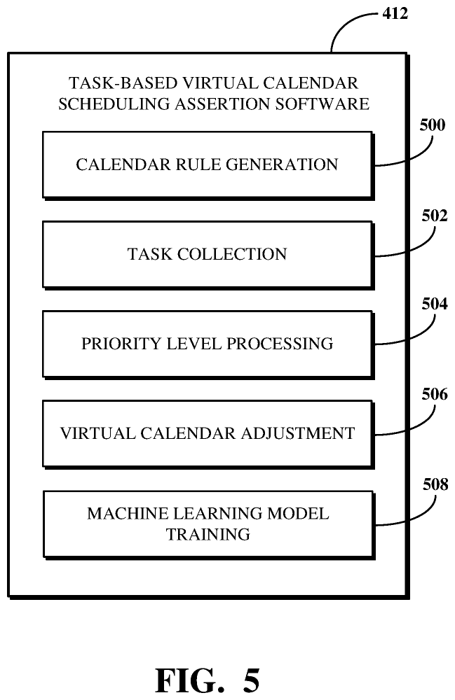

Referring to FIG. 5, a block diagram of example functionality of the task-based virtual calendar scheduling assertion software 412 is shown. The task-based virtual calendar scheduling assertion software 412 includes tools, such as programs, subprograms, functions, routines, subroutines, operations, and/or the like, for task-based virtual calendar scheduling assertion. As shown, the task-based virtual calendar scheduling assertion software 412 includes a calendar rule generation tool 500, a task collection tool 502, a priority level processing tool 504, a virtual calendar adjustment tool 506, and a machine learning model training tool 508.

The calendar rule generation tool 500 generates user-specific calendar rules for the software user by modeling trend and priority data for meetings and tasks associated with the software user. The user-specific calendar rules are rules indicating how and when to prioritize certain events (e.g., for meetings or tasks) against others based on the trend and priority data, which are modeled to determine behaviors specific to the software user related to meetings and tasks as well as prioritizations of certain of such meetings and tasks.

Trend data as may be modeled by the task-based virtual calendar scheduling assertion software 412 generally refers to determined trends in behaviors of the software user relative to certain meetings or other appointments or to certain types of meetings or other appointments. Priority data as may be modeled by the task-based virtual calendar scheduling assertion software 412 generally refers to the determined importance of certain meetings or other appointments or to certain types of meetings or other appointments, in which such determined importance is represented using priority levels. A priority level may be expressed in terms of a category (e.g., low, medium, and high) or in terms of a rating (e.g., 1-10). The user-specific calendar rules data 414 represents data indicative of user-specific calendar rules generated for the software user by the task-based virtual calendar scheduling assertion software 412. For example, the user-specific calendar rules data 414 may represent the output of the calendar rule generation tool 500. The user-specific calendar rules data 414 may be stored in a data store accessible to the client application 406. For example, the data store used to store the user-specific calendar rules data 414 may be local to the user device 402 and/or remote, such as on the server device 404 or another server.

The calendar rule generation tool 500 generates the user-specific calendar rules based on information obtained from the server device 404. In particular, referring back to FIG. 4, user records data 418 stored at the server device may be accessed and used by the task-based virtual calendar scheduling assertion software 412 and used by the calendar rule generation tool 500 to generate one or more user-specific calendar rules for the software user. The user records data 418 is data indicative or otherwise representative of historical meeting attendance, historical task performance, historical availability, and/or historical unavailability. The calendar rule generation tool 500 processes the user records data 418 to infer patterns in availability and behavior of the software user. For example, the user records data 418 may correspond to communications facilitated using the server-side communication software 416 in which the software user was involved. As such, the user records data 418 may indicate, include, represent, or otherwise correspond to the content of one or more communications involving the software user over one or more modalities. For example, where data of the user records data 418 corresponds to a one-time or recurring meeting (e.g., an audio or video conference implemented via conferencing software as the server-side communication software 416), the data may indicate whether the software user spoke or remained silent at the one-time or recurring meeting and/or the actual content of the speech from the software user at the one-time or recurring meeting (where the software user spoke at same). Similarly, where the meeting is a video conference, the data may indicate whether the software user enables video from the user device 402 or disables video for the meeting. In another example, where data of the user records data 418 corresponds to an email chain on which the software user is included (i.e., in the “to” field or the “cc” field), the data may indicate whether the software user participated in the email chain or was merely a recipient of the email messages thereof. The user records data 418 may be produced or otherwise output by the server-side communication software 416 in real-time or after a completion of the subject communication (e.g., during a video conference or after a video conference ends).

In some cases, participation or non-participation in a meeting may be inferred based on contents of the user records data 418 unrelated to the meeting. For example, where a recurring meeting is labeled as a hiking expedition on which the software user has been invited, but the software user has expressed in a chat message or email message that they dislike hiking, non-participation may be inferred based on the expression by the software user. In some such cases, a user-specific calendar rule may indicate to automatically decline events the software user is invited to but for which non-participation is inferred and priority data indicates a low priority.

While the user records data 418 are shown and described as being at the server device 404, in some implementations, some or all of the user records data 418 may be at the user device 402. For example, emails accessible via the client-side communication software 408 may be stored locally at the user device 402 and used by the calendar rule generation tool 500 as described herein to generate one or more user-specific calendar rules.

A user-specific calendar rule may be generated based on information other than that of inferred participation behaviors, such as in addition to or instead of such behavioral information. In particular, a user-specific calendar rule may be determined based on calendar-related information, such as relative to a specific day of the week (e.g., Tuesdays) or date (the first day of the month or the third Thursday of the month). For example, the trend and priority data may indicate that the software user typically has half as many meetings on Tuesdays than on other days, and the calendar rule generation tool 500 may accordingly generate a user-specific calendar rule indicating to prioritize task-related event scheduling on Tuesdays. In another example, the trend and priority data may indicate that the software user typically does not work past 3 PM local time on Fridays, and the calendar rule generation tool 500 may accordingly generate a user-specific calendar rule indicating not to schedule events on the virtual calendar 410 after 3 PM local time on Fridays.

The user-specific calendar rules are generated based on both of the trend data and the priority data. As such, participation or non-participation by the software user in certain meetings or types of meetings may be weighed against priority data for those meetings to determine user-specific calendar rules corresponding to those meetings or types of meetings. For example, the trend data may indicate that the software user does not participate in a recurring meeting, but the priority data corresponding to that recurring meeting may indicate a high priority level based on the subject matter or one or more interested parties hosting or otherwise attending the meeting. In another example, the trend data may indicate that the meeting has a high priority based on the presence of at least one participant external to an organization of the software user. For example, a participant may be determined to be external to the organization of the software user where the participant has an email address (e.g., known based on registration with the software platform) corresponding to a domain other than a domain used by the organization.

The task collection tool 502 obtains a set of pending tasks for the software user. As will be described below, the task-based virtual calendar scheduling assertion software 412 asserts the user-specific calendar rules against the virtual calendar 410 based on a set of pending tasks of the software user. The set of pending tasks indicates all tasks remaining open for actioning by the software user. A task as may be included in the set of pending tasks generally refers to something that has been either directly or indirectly assigned to the software user to handle. For example, a task may relate to some work on a project, a deliverable due to a customer, a follow-up item, or another professional or otherwise work-related matter. In some cases, a task may be other than relative to the professional work of the software user. For example, one or more tasks of the set of pending tasks may be personal in nature to the software user (e.g., scheduling a medical appointment, attending a friend's wedding or a child's concert recital, or completing insurance paperwork). Some tasks may be actionable from any location and without requiring specific or otherwise special resources. Other tasks may require actioning from a certain location and/or using certain specific or otherwise special resources. For example, a first task to write a project specification document may be actioned from any location using general word processing software available on any of multiple devices usable by the software user, while a second task to bind physical copies of a user manual may require a specific machine present at an office premises and thus require the software user to be at the office premises to action it.

The task collection tool 502 may obtain tasks of the set of pending tasks from one or more sources internal and/or external to the software platform. For example, one or more tasks may be determined based on their presence within a task list of the software user, such as which may be maintained using the client application 406 or other software of the software platform. In another example, one or more tasks may be determined by processing contents of communications (e.g., emails or chat messages) involving the software user, subject to the participants of those communications enabling the relevant software to provide such contents. In yet another example, one or more tasks may be determined by processing contents of non-client application software running at the user device 402, subject to the software user enabling the relevant software to provide such contents. In still a further example, one or more tasks may be determined based on a third party application integrated with the software platform, for example, using an application programming interface (API) call to that third party application. In some cases, obtaining the set of pending tasks can include determining the tasks, such as where at least some tasks of the set of pending tasks are not already expressed in a task list. In other cases, such as where all tasks of the set of pending tasks are already expressed in a task last, obtaining the set of pending tasks can include obtaining the set of pending tasks without determining the tasks.

The priority level processing tool 504 determines priority levels of tasks of the set of pending tasks and priority levels of meetings on the virtual calendar 410. The priority level for a task or a meeting may be determined based on one or more of manual user input, stack rank information, metadata factors, or prioritizations of related tasks or meetings. The manual user input may, for example, indicate an expression by the software user or another software user (e.g., a team leader or other superior of the software user within the same organization) of an importance of a task or meeting. For example, permutations of the words “important,” “urgent,” “help,” “immediate,” and the like as used within a meeting or task label (e.g., title) or description may be processed as manual user input. In another example, a prompt may be presented (e.g., by the task-based virtual calendar scheduling assertion software 412) based on a new meeting or task being created or identified (e.g., by the receipt of a meeting invitation), in which the prompt asks the software user to verify or otherwise provide a priority level for the meeting or task. The stack rank information may indicate an ordering of tasks, such as based on a user arrangement by the software user, a date arrangement indicating an order in which the tasks were added to a task list, or the like. The metadata factors are based on metadata associated with the task or meeting. For example, a metadata factor may indicate an urgency based on a perceived deadline for a task or an amount of time that a task has remained pending. In another example, a metadata factor may indicate whether a task or meeting was created by the software user or by another software user. In yet another example, the metadata factor may indicate a location at which a task is to be performed, such as where a label for the task specifies or implies a location (e.g., in which a location is implied by a task labeled “replace cables in server room,” in that the is recognized as that of an office premises associated with the software user). The prioritizations of related tasks or meetings contemplate how high or low priority levels are for such related tasks or meetings, such that the priority level for a current task or meeting may be aligned therewith.

Using the above inputs, a priority level for a given task or meeting may be determined in a manner similar to the priority levels described above with respect to the generation of the user-specific calendar rules. In one example, a task may have a high priority where it has an urgent deadline or where it requires some equipment available at a specific location the software user is expected to be at a given time. In another example, a meeting may have a high priority where a stakeholder such as a C-level officer or executive is expected to attend. In yet another example, a meeting may have a low priority where transcriptions of similar meetings (e.g., as indicated by the user records data 418) indicate a non-participation in such meetings by the software user. In some cases, the priority level for a meeting may also or instead be determined based on other participants to the meeting. For example, where a threshold number of other software users are already expected to attend a given meeting and other criteria generally indicates a low priority for the meeting for the software user, the meeting may be determined to have a low priority. In another example, where that threshold number of other software users are not already expected to attend, even though the other criteria generally indicates a low priority for the meeting for the software user, the meeting may be determined to have a high priority to emphasize an importance that the software user attend.

In some cases, a priority level for a meeting or task may be expressed as a binary value of either “high” or “low.” In some cases, a priority level for a meeting or task may be expressed as a non-binary but non-numerical value, for example, “high,” “medium,” or “low.” In some cases, a priority level for a meeting or task may be expressed as a numerical value, for example, an integer value from 1 through 10, inclusive. Other examples are also possible. Where a priority level has already been determined for a meeting or task having an inferred relationship with a current meeting or task for which a priority level is being determined (e.g., based on a subject matter similarity or a similar title), the priority level for that meeting or task may be re-used for the current meeting or task.

The virtual calendar adjustment tool 506 asserts the user-specific calendar rules against the virtual calendar 410 based on the set of pending tasks and priority levels of those tasks and of meetings on the virtual calendar 410 to determine whether to adjust some aspect of the virtual calendar 410. In particular, determines whether any task of the set of pending tasks has a higher priority level than one or more of the events (e.g., meetings or tasks) already on the virtual calendar 410. In the event such a task has a higher priority level than those one or more events on the virtual calendar 410, the virtual calendar adjustment tool 506 asserts the user-specific calendar rules to evaluate whether any of those one or more events should be removed from the virtual calendar 410 and the task with the higher priority level added thereto. In the event an event is to be removed from and the task added to the virtual calendar 410, the virtual calendar adjustment too 506 causes an adjustment to the virtual calendar 410 to remove the subject event from the virtual calendar 410 and to add a new event corresponding to the task with the higher priority level to the virtual calendar 410. For example, to cause the adjustment, the virtual calendar adjustment tool 506 can either directly adjust the virtual calendar 410 or transmit instructions, commands, or the like to software that facilitates the virtual calendar 410 (e.g., the client-side communication software 408, such as where same is an email client, or the client application 406 itself).

In an example use case, a task of the set of pending tasks of the software user related to updating a knowledgebase article may have a higher priority than a recurring meeting currently on the virtual calendar 410. The virtual calendar adjustment tool 506 compares the priority levels of that task and of that meeting to determine same. Based on such determination, the virtual calendar adjustment tool 506 asserts the user-specific calendar rules to validate the change. For example, a user-specific calendar rule may indicate that the recurring meeting can be replaced given that the software user historically and generally does not participate in it. The virtual calendar 410 is accordingly adjusted to remove the meeting therefrom and to add thereto a new event corresponding to the updating a knowledgebase article task, scheduled for some or all of the same timeslot during which the now removed meeting was previously scheduled. In another example use case following the same task and meeting example, a user-specific calendar rule may indicate to prevent the meeting from being replaced despite it having a lower priority level than the task where the software user has missed the N (e.g., three) past occurrences of that recurring meeting. In such a case, despite the task having a higher priority level than the meeting, the virtual calendar adjustment tool 506 does not adjust the virtual calendar 410 by removing the meeting and adding a new event corresponding to the task.

In some implementations, a predicted amount of time required for completing a given task may be compared against the virtual calendar 410 to ensure such an amount of time may be available before asserting a user-specific calendar rule to add an event for the task to the virtual calendar 410. For example, the task-based virtual calendar scheduling assertion software 412 may include functionality for predicting such amounts of time, for example, as part of the calendar rule generation functionality described above with respect to the calendar rule generation tool 500. In some such implementations, predicting an amount of time required for a given task can include modeling the trend and/or priority data relevant to the given task (e.g., based on subject matter, naming, or other similarities to the given task), such as to determine historical amounts of time spent completing similar tasks. For example, a task of the set of pending tasks for the software user may be labeled as “complete competency test.” The trend data for the software user may indicate that it typically takes the software user, on average, three hours to complete this task. The task-based virtual calendar scheduling assertion software 412 may thus verify that at least three hours are available for the task prior to asserting the relevant user-specific calendar rule for this task. In a related example, where past such tasks have been labeled as “complete competency test” but a task of the set of pending tasks instead is labeled as “do competency,” the task-based virtual calendar scheduling assertion software 412 may infer a subject matter relationship to the user-specific calendar rule indicating to verify three hours of available for “complete competency test” tasks based on a keyword or related comparison. In that the user-specific calendar rules are generated specific to the subject software user, other amounts of time may be modeled and thus determined for the same tasks for other software users, such as where the historic trend data for those other software users indicate that individuals ones of them require amounts of time other than those determined for the subject software user described herein.

In some implementations, an expected location of the software user at a timeslot for which a user-specific calendar rule may be asserted may be determined and used to verify the assertion of the user-specific calendar rule. For example, where a given task of a set of pending tasks of the software user requires the software user to be in a particular location (e.g., based on equipment or other resource availability), the virtual calendar adjustment tool 506 can verify that the software user will be at such location at a time when the given task will be added to the virtual calendar 410 before asserting a subject user-specific calendar rule to cause the given task to be so added to the virtual calendar 410.

In some implementations, asserting a user-specific calendar rule to adjust the virtual calendar 410 can include transmitting a request to modify a virtual calendar of one or more other software users and/or an indication of the modification to the virtual calendar 410. For example, where the virtual calendar adjustment tool 506 modifies the virtual calendar 410 by the user-specific calendar rule assertion to remove a meeting and add a time period for the software user to action a task, the virtual calendar adjustment tool 506 may transmit an indication to an owner of the meeting (e.g., a meeting host or other interested party) to indicate that the software user will not be attending the meeting. In another example, where the virtual calendar adjustment tool 506 modifies the virtual calendar 410 by the user-specific calendar rule assertion to remove some event and add a task to be performed by the software user and one or more other users or a task managed or otherwise overseen by the one or more other users, the virtual calendar adjustment tool 506 may automatically generate and transmit to devices of those one or more other users an invitation to add a new calendar event associated with the task to their virtual calendars.

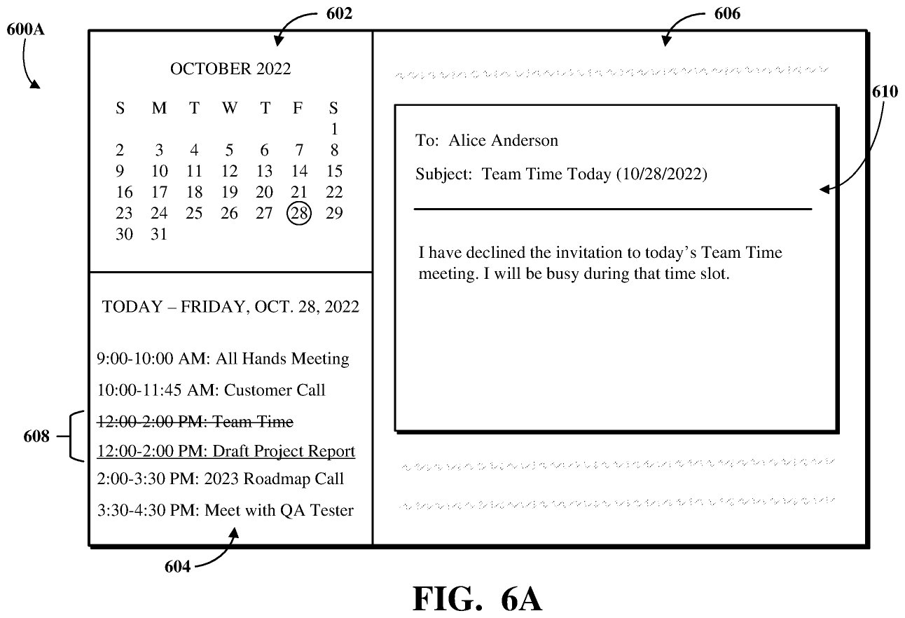

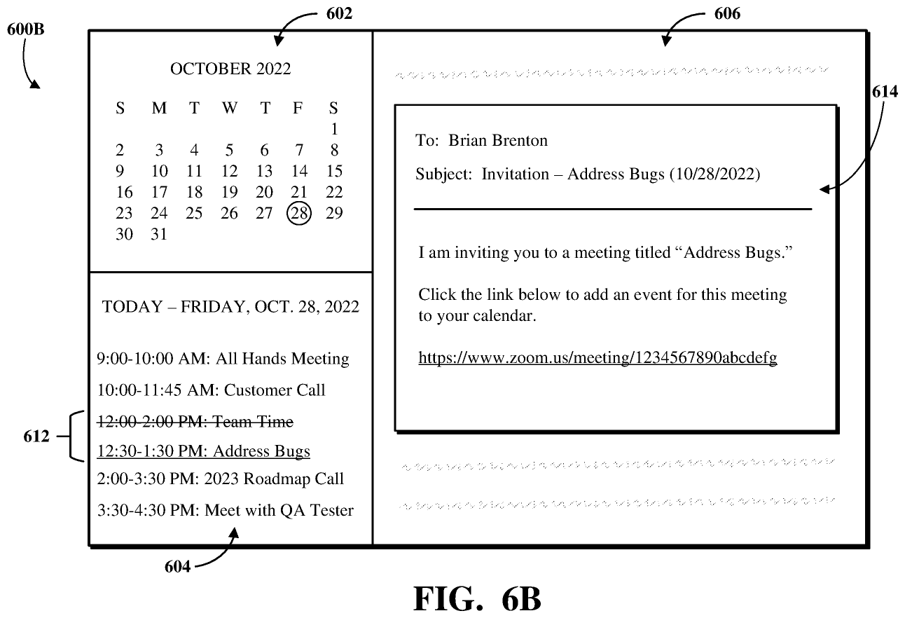

FIGS. 6A-B are illustrations of example GUIs of an email client that facilitates a virtual calendar of a software user. The email client may, for example, be software of a software platform (e.g., the software platform 300) used by the software user. In particular, the email client may be a software application via which the software user reads and/or writes emails and views and/or interacts with the virtual calendar of the software user (e.g., the virtual calendar 410). Referring first to FIG. 6A, a first GUI 600A is shown. The first GUI 600A includes a calendar region 602, a daily schedule region 604, and an email region 606. The date Oct. 28, 2022 is circled in the calendar region 602 to indicate that it is the current date. The schedule region 604 depicts the portion of the virtual calendar of the software user corresponding to the current date. As shown, the portion of the virtual calendar corresponding to the current date includes several events with little available time between them.

The task-based virtual calendar scheduling assertion software 412 may process the events shown in the schedule region 604 against a set of pending tasks for the software user to adjust the virtual calendar of the software user. Such an adjustment is reflected in the schedule region 604. In the example shown, the events from the virtual calendar initially include an all hands meeting from 9:00 AM to 10:00 AM, a customer call from 10:00 AM to 11:45 AM, a team time meeting from 12:00 PM to 2:00 PM, a 2023 roadmap call from 2:00 PM to 3:30 PM, and a meeting with a quality assurance (QA) tester from 3:30 PM to 4:30 PM. While not shown, the set of pending tasks may include a task related to drafting a project report. In particular, the priority level for that task may be relatively high based on, for example, an urgent deadline for delivering the report, an importance of the party who will receive the report, and/or a length of time that the drafting task has remained open on a task list of the software user.

The task-based virtual calendar scheduling assertion software 412, such as via the virtual calendar adjustment tool 506, may determine that the priority level for the task is higher than the priority level of one or more of the events shown in the schedule region 604. In particular, a priority level for the all hands meeting, customer call, 2023 roadmap call, and QA tester meeting may all be high due to, for example, an importance of those various events. However, a priority level for the team time meeting may be low due, for example, to a perceived low participation level of the software user in similar meetings. As such, the task-based virtual calendar scheduling assertion software 412 here has determined that the priority level for the project report drafting task is higher than the priority level for the team time meeting and has accordingly adjusted the virtual calendar to remove the team time meeting therefrom and to add a new event corresponding to the project report drafting task thereto. These adjustments 608 are shown by the team time meeting event being stricken through in the schedule region 604 and by the draft project report event being underlined in the schedule region 604.

In response to this virtual calendar adjustment, the email client, such as via a command or instruction from the task-based virtual calendar scheduling assertion software 412, automatically generates a new email message 610 to deliver to an interested party associated with the team time meeting event that was removed from the virtual calendar. For example, the interested party may be the host of a video conference scheduled for the team time meeting event (e.g., using the conferencing software 314). Here, the interested party is Alice Anderson, and the email message 610 indicates that the software user has declined the team time meeting event and thus will not be attending. In some cases, the email message 610 may be presented within the GUI 600A and thus at the device of the software user before the email message 610 is transmitted to the intended recipient, such as to allow the software user to verify and/or modify the email message 610 before such transmission. In some cases, the email message 610 may be transmitted upon (e.g., in response to) the automatic generation thereof. In this example, the project report drafting task newly added to the virtual calendar does not involve other software users, so no meeting invitations to others are required for the project report drafting task.

Referring next to FIG. 6B, a second GUI 600B is shown. The second GUI 600B includes the same calendar region 602, schedule region 604, and email region 606 as are shown in FIG. 6A. Here, however, the task-based virtual calendar scheduling assertion software 412 may process the events shown in the schedule region 604 against the set of pending tasks for the software user to determine that the priority level for the team time meeting event is lower than a priority level determined for an address bugs task of the set of pending tasks of the software user. Based on that determination, the task-based virtual calendar scheduling assertion software 412 adjusts the virtual calendar of the software user by removing the team time meeting therefrom and to add a new event corresponding to the address bugs task thereto. These adjustments 612 are shown by the team time meeting event being stricken through in the schedule region 604 and by the address bugs event being underlined in the schedule region 604.

In response to this virtual calendar adjustment, the email client, such as via a command or instruction from the task-based virtual calendar scheduling assertion software 412, automatically generates a new email message 614 to deliver to an interested party associated with the address bugs event that was added to the virtual calendar. For example, the interested party may be another software user who also has the same task on their set of pending tasks. In another example, the interested party may be inferred based on text associated with the subject task within the set of pending tasks of the software user (e.g., where the task in the set of pending tasks is described as “address bugs with [other user name]”). Here, the interested party is Brian Brenton, and the email message 614 indicates that the software user has an event related to the address bugs task and includes a link to a meeting invitation for the event. The recipient can click on the link to either cause the address bugs event to also appear on their virtual calendar and/or join a conference for the event at the scheduled time. In some cases, another email may be automatically generated and manually or automatically transmitted, as described above with respect to FIG. 6A, to indicate to an interested party associated with the team time meeting event that the software user has declined that event.

While first GUI 600A and the second GUI 600B are shown as not depicting a task list usable to obtain the set of pending tasks for the software user, the implementations of this disclosure are not so limited. In particular, in some implementations, an email client such as the one depicted in the first GUI 600A and the second GUI 600B may include a task list tool for allowing a software user to view and/or interact with (i.e., add to, remove from, or otherwise modify) a task list. In some such cases, the email client includes and thus manages the task list. In other such cases, the email client accesses the data of the task list from an external source. While the examples shown and described with respect to FIGS. 6A-B describe asserting user-specific virtual calendar rules against a virtual calendar to adjust the virtual calendar for a same day, the implementations of this disclosure are not so limited. In particular, a virtual calendar may in many be adjusted as disclosed herein to change events for a day other than a current day.

Referring back to FIG. 5, the machine learning model training tool 508 trains a machine learning model to perform some or all of the processing described in the tools 500 through 506. A machine learning model as used herein may be one or more of a neural network (e.g., a convolutional neural network, recurrent neural network, or other neural network), decision tree, vector machine, Bayesian network, genetic algorithm, deep learning system separate from a neural network, or other machine learning model. The machine learning model may be supervised or unsupervised. The machine learning model applies intelligence to identify complex patterns in the input and to leverage those patterns to produce output and refine systemic understanding of how to generate and/or assert user-specific calendar rules against the virtual calendar 410.

In particular, a machine learning model as used herein may be trained using a training data set including trend data and priority data as is modeled to generate the user-specific rules. For example, the machine learning model may be trained to recognize patterns in software user participation or non-participation based on certain meetings or types of meetings. In another example, the machine learning model may be trained to recognize patterns in priority levels based on who other participants to the meetings are. Training the machine learning model can include incrementally inputting portions of the training data set and using same to update the patterns recognized by the machine learning model. The trained machine learning model may then be used for inference, such as to determine a priority level for a meeting or task and/or to determine to assert one or more user-specific calendar rules against the virtual calendar of the software user to change their virtual calendar in some manner as described herein.

Although the tools 500 through 508 are shown as functionality of the task-based virtual calendar scheduling assertion software 412 as a single piece of software, in some implementations, some or all of the tools 500 through 508 may exist outside of the task-based virtual calendar scheduling assertion software 412 and/or the client application 406 may exclude the task-based virtual calendar scheduling assertion software 412 while still including the some or all of tools 500 through 508 in some form elsewhere or otherwise while some or all of the tools 500 through 508 are still included in some form elsewhere. For example, some or all of the tools 500 through 508 may be implemented on a server, such as the server device 404.

Referring finally back to FIG. 4, while the client-side communication software 408, the virtual calendar 410, the task-based virtual calendar scheduling assertion software 412, and the user-specific calendar rules data 414 are shown as separate elements of the client application 406, in some implementations, some or all of the client-side communication software 408, the virtual calendar 410, the task-based virtual calendar scheduling assertion software 412, and the user-specific calendar rules data 414 may be combined into one or more elements of the client application. Furthermore, in some implementations, one or more of the client-side communication software 408, the virtual calendar 410, the task-based virtual calendar scheduling assertion software 412, or the user-specific calendar rules data 414 may be external to the client application 406.

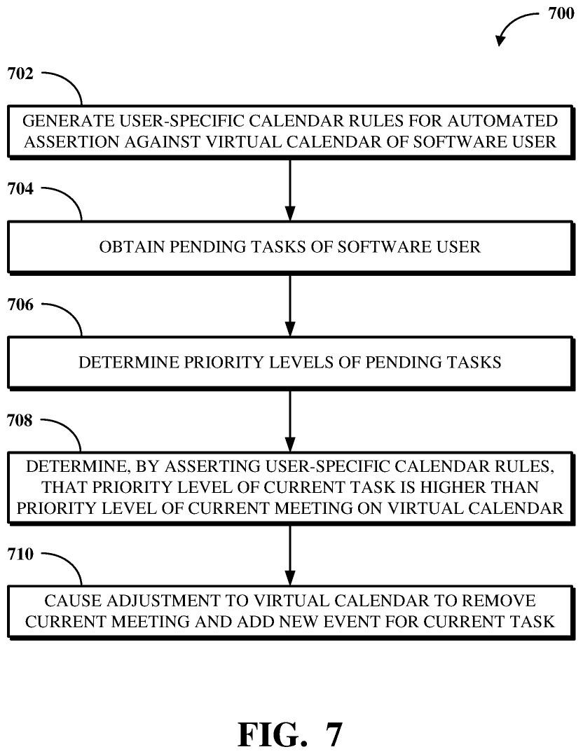

To further describe some implementations in greater detail, reference is next made to examples of techniques which may be performed by or using a system for task-based virtual calendar scheduling assertion. FIG. 7 is a flowchart of an example of a technique 700 for task-based virtual calendar scheduling assertion. The technique 700 can be executed using computing devices, such as the systems, hardware, and software described with respect to FIGS. 1-6. The technique 700 can be performed, for example, by executing a machine-readable program or other computer-executable instructions, such as routines, instructions, programs, or other code. The steps, or operations, of the technique 700, or another technique, method, process, or algorithm described in connection with the implementations disclosed herein, can be implemented directly in hardware, firmware, software executed by hardware, circuitry, or a combination thereof.

For simplicity of explanation, the technique 700 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 702, user-specific calendar rules are generated. The user-specific calendar rules are rules for automated assertion against a virtual calendar of a software user. The user-specific calendar rules are generated by modeling trend and priority data for meetings and tasks associated with a software user. As such, the user-specific calendar rules are specific to the software user (i.e., as opposed to be generated based on data aggregated across multiple software users). In one example in which the virtual calendar is facilitated by an email client, generating the user-specific calendar rules includes determining a trend in one or both of a participation or a non-participation by the software user within an email chain, and generating a user-specific calendar rule according to the trend. In another example, generating the user-specific calendar rules includes generating a user-specific calendar rule indicating to deprioritize recurring meetings for which the trend and priority data indicates a trend of low participation by the software user. In some implementations, such as where the software user is a user of a UCaaS platform that includes the virtual calendar, generating the user-specific calendar rules can include evaluating messages transmitted to the software user over multiple modalities via software services of the UCaaS platform. In some implementations, a trained machine learning model may be used to generate the user-specific calendar rules. In some such implementations, the machine learning model may be trained using messages transmitted over one or more modalities via one or more software services of the software platform (e.g., the UCaaS platform) to generate the user-specific calendar rules.

At 704, pending tasks of the software user are obtained. In particular, a set of pending tasks of the software user is obtained, in which some or all of the pending tasks of the set of pending tasks may be derived from a source internal to a software platform which, via a software service, facilitates the virtual calendar of the software user. For example, a first subset of the set of pending tasks may derive from one or more sources internal to the software platform and a second subset of the set of pending tasks may derive from one or more sources external to the software platform. In one such case, one or more tasks of the set of pending tasks may be obtained from a third party application integrated with the software platform, such as using an API call to the third party application. For example, at least one task of the set of pending tasks may be obtained based on an integration between an email client facilitating the virtual calendar and a source external to the software platform. In other cases, the entire set of pending tasks may accordingly be obtained from a third party application integrated with the software platform using an API call to the third party application. In some implementations, the set of pending tasks may include one or more tasks assigned other than by the software user. In some implementations, the set of pending tasks includes one or more tasks specific to the software user and one or more tasks enforced against multiple software users. For example, some of the pending tasks may be specific to the software user while others may be tasks awaiting action, separately or collectively, by other software users (e.g., completing compliance testing).

At 706, priority levels of the pending tasks of the software user are determined 708. The priority levels of the pending tasks may be determined based on various inputs, including, without limitation, manual user input, metadata factors, and the like. In some cases, the priority level of a current task may be determined based on trends determined for other software users based on actions performed by the other software users in connection with tasks similar to the current task. For example, while the user-specific calendar rules are generated specific to the subject software user, priority level information for tasks may in some cases be aggregated across multiple software users. In some cases, priority levels may be determined for meetings already on the virtual calendar of the software user in addition to the pending tasks. For example, the priority level of the a current, recurring meeting may be determined by evaluating data associated with one or more past occurrences of the current meeting. In some such cases, the data may be indicative of a trend of action or inaction by the software user with the one or more past occurrences of the current meeting. In some cases, determining the priority level of a task can include extrapolating resource requirements for performing the current task based on input specified by the software user for the current task. For example, the resource requirements may relate to equipment or other resources required to action the task and may be extrapolated (e.g., inferred) based on metadata factors or manual user input associated with the task. In some cases, determining the priority level of a task can include determining the priority level based on one or more of a current activity of the software user, a location at which the software user is expected to perform the current task, or a historical preference of the software user relative to tasks related to the current task.

At 708, a determination that a priority level of a current task is higher than a priority level of an event (e.g., for a current meeting) on the virtual calendar of the software user. The determination is made by asserting the user-specific calendar rules generated for the software user. In some cases, asserting a user-specific calendar rule to determine that a priority level of the current task is higher than a priority level of the event, in which the current task requires a resource located at a premises, may include determining that the software user will be present at the premises at a time of the current meeting. In the event that the priority level of a task is the same as a priority level for the event on the virtual calendar, the software user may be prompted to indicate which to retain on the virtual calendar and which to discard. In some cases, an automated decision may be made to retain the existing event and thus to not cause an adjustment to the virtual calendar based on the current task.

At 710, based on the determination that the priority level of the current task is higher than the priority level of the current meeting on the virtual calendar of the software user, an adjustment is caused to the virtual calendar of the software user to remove the current meeting therefrom and to add a new event corresponding to the current task thereto. For example, causing the adjustment to the virtual calendar may include automatically adjusting the virtual calendar to remove the current meeting from the virtual calendar and to add the new event to the virtual calendar in response to determining that the priority of the current task is higher than the priority level of the current meeting. In another example, causing the adjustment to the virtual calendar may include prompting the software user with a recommendation to remove the current meeting from the virtual calendar and to add the new event to the virtual calendar in response to determining that the priority of the current task is higher than the priority level of the current meeting. In either such case, causing the adjustment to the virtual calendar may, for example, include instruct an email client facilitating the virtual calendar to remove the current meeting from the virtual calendar and to add the new event to the virtual calendar.

The implementations of this disclosure correspond to methods, non-transitory computer readable media, apparatuses, systems, devices, and the like. In some implementations, a method comprises: generating, by modeling trend and priority data for meetings and tasks associated with a software user, user-specific calendar rules for automated assertion against a virtual calendar of the software user; obtaining a set of pending tasks of the software user; determining, by asserting the user-specific calendar rules against the virtual calendar, that a priority level of a current task of the set of pending tasks is higher than a priority level of a current meeting scheduled on the virtual calendar; and causing an adjustment to the virtual calendar to remove the current meeting and add a new event corresponding to the current task. In some implementations, a non-transitory computer readable medium stores instructions operable to cause one or more processors to perform operations comprising: generating, by modeling trend and priority data for meetings and tasks associated with a software user, user-specific calendar rules for automated assertion against a virtual calendar of the software user; obtaining a set of pending tasks of the software user; determining, by asserting the user-specific calendar rules against the virtual calendar, that a priority level of a current task of the set of pending tasks is higher than a priority level of a current meeting scheduled on the virtual calendar; and causing an adjustment to the virtual calendar to remove the current meeting and add a new event corresponding to the current task. In some implementations, an apparatus comprises a memory and a processor configured to execute instructions stored in the memory to: generate, by modeling trend and priority data for meetings and tasks associated with a software user, user-specific calendar rules for automated assertion against a virtual calendar of the software user; obtain a set of pending tasks of the software user; determine, by asserting the user-specific calendar rules against the virtual calendar, that a priority level of a current task of the set of pending tasks is higher than a priority level of a current meeting scheduled on the virtual calendar; and cause an adjustment to the virtual calendar to remove the current meeting and add a new event corresponding to the current task.

In some implementations of the method, non-transitory computer readable medium, or apparatus, the virtual calendar is facilitated by an email client, and generating the user-specific calendar rules comprises: determining a trend in one or both of a participation or a non-participation by the software user within an email chain; and generating a user-specific calendar rule according to the trend.

In some implementations of the method, non-transitory computer readable medium, or apparatus, generating the user-specific calendar rules comprises: generating a user-specific calendar rule indicating to deprioritize recurring meetings for which the trend and priority data indicates a trend of low participation by the software user.

In some implementations of the method, non-transitory computer readable medium, or apparatus, the current task requires a resource located at a premises, and determining that the priority level of the current task is higher than the priority level of the current meeting comprises: determining that the software user will be present at the premises at a time of the current meeting.

In some implementations of the method, non-transitory computer readable medium, or apparatus, the set of pending tasks is obtained from a third party application integrated with a software platform implementing the virtual calendar using an application programming interface call.

In some implementations of the method, non-transitory computer readable medium, or apparatus, the set of pending tasks includes one or more tasks assigned other than by the software user.

In some implementations of the method, non-transitory computer readable medium, or apparatus, the method comprises, the operations comprise, or the processor is configured to execute the instructions for determining priority levels of tasks of the set of pending tasks.

In some implementations of the method, non-transitory computer readable medium, or apparatus, causing the adjustment to the virtual calendar comprises: automatically adjusting the virtual calendar to remove the current meeting from the virtual calendar and to add the new event to the virtual calendar in response to determining that the priority of the current task is higher than the priority level of the current meeting.

In some implementations of the method, non-transitory computer readable medium, or apparatus, causing the adjustment to the virtual calendar comprises: prompting the software user with a recommendation to remove the current meeting from the virtual calendar and to add the new event to the virtual calendar in response to determining that the priority of the current task is higher than the priority level of the current meeting.

In some implementations of the method, non-transitory computer readable medium, or apparatus, the method comprises, the operations comprise, or the processor is configured to execute the instructions for training a machine learning model using messages transmitted over one or more modalities via one or more software services of a unified communications as a service platform to generate the user-specific calendar rules.

In some implementations of the method, non-transitory computer readable medium, or apparatus, the software user is a user of a unified communications as a service platform that includes the virtual calendar, and generating the user-specific calendar rules comprises: evaluating messages transmitted to the software user over multiple modalities via software services of the unified communications as a service platform.

In some implementations of the method, non-transitory computer readable medium, or apparatus, the set of pending tasks includes one or more tasks specific to the software user and one or more tasks enforced against multiple software users.

In some implementations of the method, non-transitory computer readable medium, or apparatus, the method comprises, the operations comprise, or the processor is configured to execute the instructions for determining the priority level of the current task based on trends determined for other software users based on actions performed by the other software users in connection with tasks similar to the current task.

In some implementations of the method, non-transitory computer readable medium, or apparatus, the current meeting is a recurring meeting, and the method comprises, the operations comprise, or the processor is configured to execute the instructions for determining the priority level of the current meeting by evaluating data associated with one or more past occurrences of the current meeting, wherein the data is indicative of a trend of action or inaction by the software user with the one or more past occurrences.

In some implementations of the method, non-transitory computer readable medium, or apparatus, causing the adjustment to the virtual calendar comprises: instructing an email client facilitating the virtual calendar to remove the current meeting from the virtual calendar and to add the new event to the virtual calendar.

In some implementations of the method, non-transitory computer readable medium, or apparatus, the method comprises, the operations comprise, or the processor is configured to execute the instructions for determining the priority level of the current task by extrapolating resource requirements for performing the current task based on input specified by the software user for the current task.

In some implementations of the method, non-transitory computer readable medium, or apparatus, the method comprises, the operations comprise, or the processor is configured to execute the instructions for determining the priority level of the current task based on one or more of a current activity of the software user, a location at which the software user is expected to perform the current task, or a historical preference of the software user relative to tasks related to the current task.

In some implementations of the method, non-transitory computer readable medium, or apparatus, at least one task of the set of pending tasks is obtained based on an integration between an email client facilitating the virtual calendar and a source external to a software platform which includes the email client.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
generating, by modeling trend and priority data for meetings and tasks associated with a software user, user-specific calendar rules for automated assertion against a virtual calendar of the software user;
obtaining a set of pending tasks of the software user;
determining, by asserting the user-specific calendar rules against the virtual calendar, that a priority level of a current task of the set of pending tasks is higher than a priority level of a current meeting scheduled on the virtual calendar; and
causing an adjustment to the virtual calendar to remove the current meeting and add a new event corresponding to the current task.

2. The method of claim 1, wherein the virtual calendar is facilitated by an email client, and wherein generating the user-specific calendar rules comprises:
determining a trend in one or both of a participation or a non-participation by the software user within an email chain; and
generating a user-specific calendar rule according to the trend.

3. The method of claim 1, wherein generating the user-specific calendar rules comprises:
generating a user-specific calendar rule indicating to deprioritize recurring meetings for which the trend and priority data indicates a trend of low participation by the software user.

4. The method of claim 1, wherein the current task requires a resource located at a premises, and wherein determining that the priority level of the current task is higher than the priority level of the current meeting comprises:
determining that the software user will be present at the premises at a time of the current meeting.

5. The method of claim 1, wherein the set of pending tasks is obtained from a third party application integrated with a software platform implementing the virtual calendar using an application programming interface call.

6. The method of claim 1, wherein the set of pending tasks includes one or more tasks assigned other than by the software user.

7. The method of claim 1, comprising:
determining priority levels of tasks of the set of pending tasks.

8. The method of claim 1, wherein causing the adjustment to the virtual calendar comprises:
automatically adjusting the virtual calendar to remove the current meeting from the virtual calendar and to add the new event to the virtual calendar in response to determining that the priority of the current task is higher than the priority level of the current meeting.

9. The method of claim 1, wherein causing the adjustment to the virtual calendar comprises:
prompting the software user with a recommendation to remove the current meeting from the virtual calendar and to add the new event to the virtual calendar in response to determining that the priority of the current task is higher than the priority level of the current meeting.

10. The method of claim 1, comprising:
training a machine learning model using messages transmitted over one or more modalities via one or more software services of a unified communications as a service platform to generate the user-specific calendar rules.

11. A non-transitory computer readable medium storing instructions operable to cause one or more processors to perform operations comprising:
generating, by modeling trend and priority data for meetings and tasks associated with a software user, user-specific calendar rules for automated assertion against a virtual calendar of the software user;
obtaining a set of pending tasks of the software user;
determining, by asserting the user-specific calendar rules against the virtual calendar, that a priority level of a current task of the set of pending tasks is higher than a priority level of a current meeting scheduled on the virtual calendar; and
causing an adjustment to the virtual calendar to remove the current meeting and add a new event corresponding to the current task.

12. The non-transitory computer readable medium of claim 11, wherein the software user is a user of a unified communications as a service platform that includes the virtual calendar, and wherein the operations for generating the user-specific calendar rules comprise:
evaluating messages transmitted to the software user over multiple modalities via software services of the unified communications as a service platform.

13. The non-transitory computer readable medium of claim 11, wherein the set of pending tasks includes one or more tasks specific to the software user and one or more tasks enforced against multiple software users.

14. The non-transitory computer readable medium of claim 11, the operations comprising:
determining the priority level of the current task based on trends determined for other software users based on actions performed by the other software users in connection with tasks similar to the current task.

15. The non-transitory computer readable medium of claim 11, wherein the current meeting is a recurring meeting, the operations comprising:
determining the priority level of the current meeting by evaluating data associated with one or more past occurrences of the current meeting, wherein the data is indicative of a trend of action or inaction by the software user with the one or more past occurrences.

16. An apparatus, comprising:
a memory; and
a processor configured to execute instructions stored in the memory to:
generate, by modeling trend and priority data for meetings and tasks associated with a software user, user-specific calendar rules for automated assertion against a virtual calendar of the software user;
obtain a set of pending tasks of the software user;
determine, by asserting the user-specific calendar rules against the virtual calendar, that a priority level of a current task of the set of pending tasks is higher than a priority level of a current meeting scheduled on the virtual calendar; and
cause an adjustment to the virtual calendar to remove the current meeting and add a new event corresponding to the current task.

17. The apparatus of claim 16, wherein, to cause the adjustment to the virtual calendar, the processor is configured to execute the instructions to:
instruct an email client facilitating the virtual calendar to remove the current meeting from the virtual calendar and to add the new event to the virtual calendar.

18. The apparatus of claim 16, wherein the processor is configured to execute the instructions to:
determine the priority level of the current task by extrapolating resource requirements for performing the current task based on input specified by the software user for the current task.

19. The apparatus of claim 16, wherein the processor is configured to execute the instructions to:
determine the priority level of the current task based on one or more of a current activity of the software user, a location at which the software user is expected to perform the current task, or a historical preference of the software user relative to tasks related to the current task.

20. The apparatus of claim 16, wherein at least one task of the set of pending tasks is obtained based on an integration between an email client facilitating the virtual calendar and a source external to a software platform which includes the email client.
